(19) United States
(12) Patent Application Publication
(10) Pub. No.: US 2020/0199720 A1
(43) Pub. Date: Jun. 25, 2020

(54) A TUBE MADE OF AN AUSTENITIC STAINLESS STEEL AND A METHOD FOR MANUFACTURING THEREOF

(71) Applicant: SANDVIK MATERIALS TECHNOLOGY DEUTSCHLAND GMBH, Düsseldorf (DE)

(72) Inventors: Thomas FROBÖSE, Versmold (DE); Christofer HEDVALL, Bielefeld (DE)

(73) Assignee: SANDVIK MATERIALS TECHNOLOGY DEUTSCHLAND GMBH, Düsseldorf (DE)

(21) Appl. No.: 16/638,841

(22) PCT Filed: Sep. 12, 2018
(86) PCT No.: PCT/EP2018/074550

§ 371 Date: Feb. 13, 2020

(30) Foreign Application Priority Data
Sep. 14, 2017 (DE) 10 2017 121 361.9

(51) Int. Cl. C22C 38/58; C21D 8/10; C21D 9/08; C22C 38/42; C22C 38/44; B21B 21/00; B64D 37/00; C22C 38/02

(52) U.S. Cl. CPC C22C 38/58; C21D 8/105; C21D 9/08; C22C 38/42; C21D 2211/001; B21B 21/00; B64D 37/005; C22C 38/02; C22C 38/44

(57) ABSTRACT

The present disclosure relates to a tube made of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, which is balanced by Fe and normally occurring impurities. So far tubes made of an austenitic stainless steel comprising this composition of ingredients are welded. A major problem of welded tubes is the risk for cracking, where the weld zone is the preferential location for cracking. This is especially a problem for applications under extreme conditions like in the aircraft or aerospace industry. It is therefore an aspect of the present disclosure to provide a tube made of an austenitic stainless steel comprising the foresaid components which at least overcomes one of the foresaid problems. Furthermore, it is an aspect of the disclosure to provide tubes that have less weight as tube known from the state of the art but increases the security and lead to a higher standard in the aircraft and aerospace industry. At least one of the above aspects is solved by a foresaid tube, wherein that the tube is a seamless tube.

### TECHNICAL FIELD

The present disclosure relates to a tube made of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

The present disclosure furthermore relates to a method for manufacturing a tube comprising the steps: providing a melt of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities, extruding a tubular hollow from the melt, cooling the hollow, and cold forming the hollow into the tube.

### BACKGROUND

The above-mentioned austenitic stainless steel is known as a 21-6-9 stainless steel (also denoted as UNS S21900) with a high level of Mn, a low level of Ni and the addition of N. It is characterized by high mechanical strength in the hard condition, very good impact toughness and even at temperatures down to −230° C. and very good high temperature oxidation resistance. It is commercially available and typical applications for this material are for example aircraft hydraulic tubes and an aircraft engine components.

Tubes, made of an austenitic 21-6-9 stainless steel so far have only been provided as welded tubes. A welded tube is manufactured for example by bending a flat steel sheet into a tube, and welding the joint together to form a seam. Several other manufacturing steps may follow.

A potential disadvantage of such welded tubes is the risk of cracking, wherein the weld zone is the preferential location for cracking. This circumstance was shown in fatigue experiments with welded tubes of 21-6-9 steel. Especially, this is a problem, at places where tubes are subject to extreme conditions. With extreme conditions are meant for example high mechanical stresses, high or low temperatures for example temperatures around −230° C., high temperature gradients as well as high pressures or high pressure gradients. The risk of cracking is a problem in particular in applications under extreme conditions, for example in aircrafts or in applications for the aerospace industry.

It is an aspect of the present disclosure to provide a tube made of an austenitic 21-6-9 stainless steel that overcomes at least one of the above-mentioned disadvantages. It is a further aspect of the present disclosure to provide a tube made of an austenitic stainless steel that provides lower risks and higher standards in aerospace. Another aspect of the present disclosure is to provide a tube with the same or lesser fatigue as a welded tube and which at the same time provides a reduced weight. A further aspect of the present disclosure is to provide a method for manufacturing a tube made of austenitic 21-6-9 stainless steel fulfilling the above requirements.

### SUMMARY

At least one of the above-mentioned aspects is solved by a tube according to claim 1. The tube is made of an austenitic 21-6-9 stainless steel as described above, but is a seamless tube.

The advantages of a seamless tube are an increase in the lifetime of components, the possibility to design for lower weight at equal strength as well as a better quality of the inner shape of the seamless tube when compared to a welded tube.

Another advantage of a seamless tube over a welded tube is the possibility to stand higher hoop stresses. Therefore, within a pulse pressure testing a stress-cycle (S—N) curve also known as Wöhler curve was carried out. The results showed that for welded and seamless tubes with the same outer diameter and same wall thickness, the seamless tubes will always withstand higher hoop stresses independent of the applied pressures. Consequently, it is possible to manufacture a seamless tube that has, when compared to a welded tube, a lower wall thickness but can withstand equal hoop stresses. For this reason, it is possible to save material as well as weight which is a fundamental advantage especially in applications for the aerospace industry or in other applications where it is essential to have light weight tubes and to save weight.

It should be pointed out that for those above-mentioned elements, the austenitic stainless steel comprises or consists of, where no lower limit of the content is given, the minimum in weight % can be “0”. Those elements are C, P, S, Mo and Cu.

In an embodiment the seamless tube is made of an austenitic stainless steel consisting of, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

In another embodiment, the seamless tube is made of an austenitic stainless steel consisting of or comprising the same above-mentioned elements but with a maximum content in weight % of C≤0.040.

The austenitic stainless alloy as defined hereinabove or hereinafter may optionally comprise one or more of the following elements selected from the group of Al, V, Nb, Ti, O, Zr, Hf, Ta, Mg, Pb, Co, Bi, Ca, La, Ce, Y and B. These elements may be added during the manufacturing process in order to enhance e.g. deoxidation, corrosion resistance, hot ductility and/or machinability. However, as known in the art, the addition of these elements has to be limited depending on which element is present. Thus, if added the total content of these elements is less than or equal to 1.0 weight %.

The term “impurities” as referred to herein is intended to mean substances that will contaminate the austenitic stainless alloy when it is industrially produced, due to the raw materials such as ores and scraps, and due to various other factors in the production process, and are allowed to contaminate within the ranges not adversely affecting the austenitic stainless alloy as defined hereinabove or hereinafter.

In an embodiment according to the present disclosure, the tube is obtained by a method comprising the steps: providing a melt of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities, extruding a billet from the melt, hot forming the billet into a tubular hollow, cooling the hollow, and cold forming the hollow into the tube.

In an embodiment the hot forming is effected by hot rolling.

In an embodiment, a melt of an austenitic stainless steel is provided, wherein the austenitic stainless steel consists of, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

In another embodiment of the present disclosure a melt of an austenitic stainless steel is provided, wherein the austenitic stainless steel consists of or comprises the same above-mentioned elements but with a maximum carbon content in weight % of C≤0.040.

In an embodiment of the present disclosure, the cold forming is effected by cold pilger milling or cold drawing.

In an embodiment of the present disclosure, the cold forming is effected by cold pilger milling and the tube after cold pilger milling is cold drawn through a drawing die.

In another embodiment of the present disclosure, the tube has an outer diameter of 40 mm or less and a wall thickness of 1.32 mm or less.

In yet another embodiment of the present disclosure, the tube has an outer diameter of 38.1 mm and a wall thickness of 0.8 mm.

In an embodiment of the present disclosure, the tube has an outer diameter of 38.1 mm and a wall thickness of 0.6 mm.

In yet another embodiment of the present disclosure, the tube has a wall thickness of either 0.8 mm or 0.6 mm.

In aerospace applications, there is less space available for tubings and it is essential to save weight. Thus, for aerospace applications it is necessary to manufacture tubes with thin walls.

An embodiment of the present disclosure relates to an aircraft with a fluid transmitting equipment, a fluid receiving equipment and a conduit in fluid communication with the fluid transmitting equipment and with the fluid receiving equipment for guiding a fluid between the fluid transmitting equipment and the fluid receiving equipment, wherein at least a section of the conduit is provided by a tube according to the present disclosure as it has been described in various embodiments thereof above.

It should be mentioned that the term “aircraft” in the sense of the present disclosure is to be understood broadly, such that it covers all types of airborne equipment like planes, helicopters rockets, satellites and other space equipment.

In an embodiment of the present disclosure, the fluid transmitting equipment in the aircraft is a fuel reservoir, the fluid receiving equipment is an aircraft engine and the conduit is a fuel line for guiding fuel between the fuel reservoir and the aircraft engine.

In an embodiment of the present disclosure, the aircraft engine is a turbine.

In an embodiment of the disclosure, the fluid transmitting equipment in the aircraft is a hydraulic pump, the fluid receiving equipment is a hydraulic motor and the conduit is a hydraulic line for guiding a hydraulic fluid between the hydraulic pump and the hydraulic motor.

It should be mentioned that the term “hydraulic motor” in the sense of the present disclosure is to be understood broadly, such that it covers all types of hydraulic actuators providing a linear or rotatory motion.

It should be pointed out that in an aircraft there are several locations where hydraulics are used. Some of those locations include primary flight controls, flap/slat drives, landing gear, nose wheel steering, thrust reversers, spoilers, rudders, cargo doors, and emergency hydraulic-driven electrical generators.

Normally the requirements for hydraulic systems on aircrafts or in the aerospace industry are higher than on many other industrial applications. In general, a pressure of about 200 bar is applied to the hydraulic system in an aircraft. Therefore, the tube containing the hydraulic fluid must stand these high pressures. In the aerospace industry or in military aircrafts even higher pressures are applied to the hydraulic systems. In addition, aircrafts are exposed to high temperature gradients and the temperature can fall well below zero. These extremes are even higher in applications of the aerospace industry.

Furthermore, the present disclosure relates to a use of a tube according to the present disclosure as it has been described in various embodiments thereof above as at least a section of a conduit in an aircraft being in fluid communication with a fluid transmitting equipment and with a fluid receiving equipment for guiding a fluid between the fluid transmitting equipment and the fluid receiving equipment.

Insofar, as in the foregoing as well as the following detailed description of the embodiments and claims, reference is made to either the austenitic stainless steel tube or the method for manufacturing the austenitic stainless steel tube, the features described are applicable for both the tube and the method for manufacturing the tube.

At least one of the above aspects is also solved by a method for manufacturing a tube comprising the steps: providing a melt of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities, extruding a billet from the melt, hot forming the billet into a tubular hollow, cooling the hollow, and cold forming the hollow into the tube.

A tube manufactured according to this method of the present disclosure is a seamless tube.

In an embodiment, a melt of an austenitic stainless steel is provided, wherein the austenitic stainless steel consists of, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

In another embodiment of the present disclosure, a melt of an austenitic stainless steel is provided, wherein the austenitic stainless steel consists of or comprises the same above-mentioned elements but with a maximum content in weight % of C≤0.040.

In an embodiment of the present disclosure, the step of cold forming is cold pilger milling or cold drawing.

Cold forming processes are used for forming a hollow of metal into a tube. The cold forming of the final seamless tube not only changes its properties due to strain hardening going along with the cold forming, but the tube's wall thickness is reduced as is its inner and outer diameter. By cold forming a hollow into a tube for example by cold pilger milling or cold drawing, a tube with exact dimensions can be manufactured.

Pilger milling is a widely-used method to reduce the dimensions of a tube. Pilger milling as it is considered here, is performed at room temperature and thus is known as cold pilger milling. During pilger milling (in the present method), the hollow is pushed over a calibrated mandrel defining the inner diameter of the finished tube. The hollow is engaged by two calibrated rollers defining the outer diameter of the tube. The rollers roll the hollow in a longitudinal direction over the mandrel.

At the beginning of the pilger milling process, the hollow is moved by a driver into the chuck of the feeder. At a front point of return of the roll stand in the feed direction of the hollow, the rollers have an angular position in which the hollow can be inserted into the infeed pockets of the rollers and can be located between the rollers. The two rollers being vertically mounted above each other at the roll stand, roll over the hollow by rolling back and forth in a direction parallel to the feed direction of the hollow. During the motion of the roll stand between the front point of return and the rear point of return, the rollers stretch out the hollow over the mandrel mounted inside the hollow.

The rollers and the mandrel are calibrated such that the gap formed between the rollers and the mandrel in the section of the rollers denoted as the working caliber is continuously reduced from the wall thickness of the hollow prior to the forming to the wall thickness of the completely rolled tube. Furthermore, the outer diameter defined by the rollers is reduced from the outer diameter of the hollow to the outer diameter of the finished tube. In addition, the inner diameter defined by the mandrel is reduced from the inner diameter of the hollow to the inner diameter of the finished tube.

Further to the working caliber, the rollers comprise a planing caliber. The planing caliber neither reduces the wall thickness of the tube nor the inner or the outer diameter of the tube, but is used for planing the surfaces of the tube to be manufactured. When the rollers have reached the rear point of return of the roll stand, the rollers are at an angular position, wherein the rollers form an escape pocket to bring the rollers out of engagement with the tube.

A feeding of the hollow in the feed direction occurs either at the front point of return of the roll stand or at the front point of return as well as at the rear point of return of the roll stand. In an embodiment, each section of the hollow can be rolled multiple times. In this embodiment, the steps of feeding the hollow in the feed direction are significantly smaller than the path of the roll stand from the front point of return to the rear point of return. By rolling each section of the tube multiple times, a uniform wall thickness and roundness of tube, a high surface quality of the tube as well as uniform inner and outer diameters can be achieved.

In order to obtain a uniform shape of the finalized tube, the hollow in addition to a stepwise feeding experiences an intermittent rotation about its axis of symmetry. Rotation of the hollow in an embodiment is provided at at least one point of return of the roll stand, i.e. once the hollow is out of engagement with the rollers at the infeed pockets and release pockets, respectively.

In an embodiment of the present disclosure, the tube is cold drawn instead of cold pilger milling or the tube after cold pilger milling is cold drawn.

Drawing as it is considered here, is performed at room temperature and thus is known as cold drawing.

Different methods of cold drawing can be applied as embodiments of the present disclosure, i.e. tube drawing, core drawing and rod drawing. During the process of tube drawing, only the outer diameter of the tube is reduced by drawing the tube through a drawing die without further defining the inner diameter of the tube. During core drawing and rod drawing, simultaneously the inner diameter and the wall thickness of the drawn tube are defined by a mandrel. Either the mandrel is not fixed but held by the tube itself or in rod drawing the mandrel is held by a rod extending through the inner diameter of the tube. In an embodiment, wherein a mandrel is applied during the drawing process, the drawing die and the mandrel define a ring-shaped gap through which the tube is drawn. When using a mandrel, the outer diameter, the inner diameter as well as the wall thickness may be reduced during the drawing process and the final tube has diameters within tight tolerances. A drawing equipment can either be continuously or discontinuously operated. During the drawing process, the work piece is clamped by a drive on the side of the drawing die, where the finalized tube can be gripped. In order to continuously draw the tube, the drawing equipment in an embodiment needs at least two drawing drives alternately clamping the tube in order to continuously draw the tube through the drawing die.

In an embodiment of the disclosure, the tube after cold forming, such as cold pilger milling, is treated by ring autofrettage or ball autofrettage.

This method for manufacturing a tube for aerospace leads to an enhanced yield strength and reduced crack growth.

In an embodiment of the present disclosure, the tube is after cold forming, such as after cold pilger milling or after cold pilger milling and cold drawing, annealed at a temperature in the range of from 400° C. to 460° C., wherein during annealing, the tube is kept in a controlled atmosphere.

A tube manufactured by this method will obtain high tensile strength and high elongation in high-pressure applications simultaneously.

In an embodiment of the present disclosure, the tube according to the present disclosure is used for guiding a fluid in an aircraft.

It should be mentioned that the guided fluid for example is a fuel or a hydraulic fluid.

In an embodiment of the disclosure, the fluid in the tube is pressurized at 100 bar or more.

In a further embodiment of the disclosure, the fluid in the tube is pressurized at 200 bar or more or at 300 bar or more.

It should be pointed out that hydraulic systems in aircrafts work at pressures of 300 bar or more.

### BRIEF DESCRIPTION OF THE FIGURES

Further advantages, features and applications of the present disclosure will become apparent from the following description of embodiments and the corresponding figures attached. The foregoing as well as the following detailed description of the embodiments will be better understood when read in conjunction with the appended drawings. It should be understood that the embodiments depicted are not limited to the precise arrangements and instrumentalities shown.

FIG. 1 is a schematic front view of an aircraft according to an embodiment of the present disclosure.

FIG. 2 is a schematic side view of an aircraft according to an embodiment of the present disclosure.

FIG. 3 is a flow chart of a method according to an embodiment of the present invention.

### DETAILED DESCRIPTION

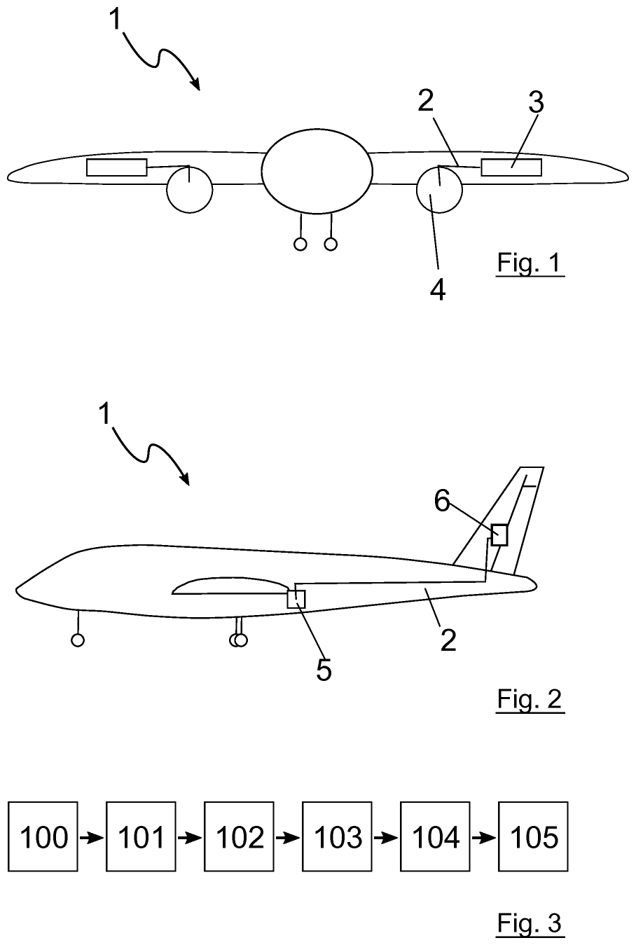

FIG. 1 is a schematic front view of an aircraft 1 according to an embodiment of the present disclosure, wherein the fluid lines are tubes 2 according to an embodiment of the present disclosure. The fuel reservoirs 3 are arranged in the wings of the aircraft 1 being in fluid communication with the turbines 4 across the tubes 2.

FIG. 2 is a schematic side view of an aircraft 1 according to an embodiment of the present disclosure, wherein the hydraulic lines are tubes 2 according to an embodiment of the present disclosure. The hydraulic pump 5 is arranged in the body of the aircraft 1 being in fluid communication with the hydraulic actuator 6 across the tubes 2.

The hydraulic fluid is pumped from a reservoir (unembodied), by the hydraulic pump 5. In order to keep the hydraulic fluid clean, usually the hydraulic fluid is filtered (unembodied). Via fluid communication across the tubes 2 the hydraulic fluid reaches the hydraulic actuator 6 and the fluid power is turned into work by a piston. This power is then used to move a rudder.

FIG. 3 is a flow chart describing a method for forming a hollow into the tube 2 used in the applications described with reference to FIGS. 1 and 2. In a first step 100, a melt of an austenitic stainless steel is provided, wherein the austenitic stainless steel consists of, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

After extruding a billet from the melt in a second step 101, the billet is hot rolled 102 into a tubular hollow. Then the hollow is cooled to room temperature in step 103. In a penultimate step 104, the hollow is cold pilger milled into a tube. In a last step 105, the tube is cold drawn through a drawing dye.

For purposes of the original disclosure, it is noted that all features become apparent for a person skilled in the art from the present description, the figures and the claims even if they have only been described with reference to particular further features and can be combined either on their own or in arbitrary combinations with other features or groups of features disclosed herein as far as such combinations are not explicitly excluded or technical facts exclude such combinations or make them useless. An extensive, explicit description of each possible combination of features has only been omitted in order to provide a short and readable description.

While the disclosure has been shown in detail in the figures and the above description, this description is only an example and is not considered to restrict the scope of protection as it is defined by the claims. The disclosure is not restricted to the disclosed embodiments.

Modifications to the disclosed embodiments are apparent for a person skilled in the art from the drawings, the description and the attached claims. In the claims, the word “comprising” does not exclude other elements or steps and the undefined article “a” does not exclude a plurality. The mere fact that some features have been claimed in different claims does not exclude their combination. Reference numbers in the claims are not considered to restrict the scope of protection.

### REFERENCE NUMERALS

1 Aircraft
2 tube
3 fuel reservoir
4 turbine
5 hydraulic pump
6 hydraulic actuator
100 providing a melt of an austenitic stainless steel
101 extruding a billet from the melt
102 hot rolling of the billet into a tubular hollow
103 cooling step
104 cold pilger milling step
105 cold drawing step

1. A tube made of an austenitic stainless steel comprising, in weight %,
C≤0.080,
8.00≤Mn≤10.00,
Si≤1.00,
P≤0.030,
S≤0.030,
19.00≤Cr≤21.50,
5.50≤Ni≤7.50,
0.15≤N≤0.40,
Mo≤0.75,
Cu≤0.75,
balance Fe and normally occurring impurities, wherein the tube is a seamless tube.

2. The tube according to claim 1, wherein the tube is obtained by a method comprising the steps
providing a melt 100 of an austenitic stainless steel comprising, in weight %,
C≤0.080,
8.00≤Mn≤10.00,
Si≤1.00,
P≤0.030,
S≤0.030,
19.00≤Cr≤21.50,
5.50≤Ni≤7.50,
0.15≤N≤0.40,
Mo≤0.75,
Cu≤0.75,
balance Fe and normally occurring impurities;
extruding a billet from the melt;
hot forming of the billet into a tubular hollow;
cooling the hollow; and
cold forming the hollow into the tube.

3. The tube according to claim 2, wherein the cold forming is cold pilger milling or cold drawing.

4. The tube according to claim 3, wherein the tube is cold formed by cold pilger milling and the tube after cold pilger milling is cold drawn through a drawing die.

5. The tube according to claim 1, wherein the tube has an outer diameter of 40 mm or less and a wall thickness of 1.32 mm or less.

6. An aircraft with a fluid transmitting equipment, a fluid receiving equipment and a conduit in fluid communication with the fluid transmitting equipment and with the fluid receiving equipment for guiding a fluid between the fluid transmitting equipment and the fluid receiving equipment, wherein at least a section of the conduit is provided by the tube according to claim 1.

7. The aircraft according to claim 6, wherein the fluid transmitting equipment is a fuel reservoir, the fluid receiving equipment is an aircraft engine, and the conduit is a fuel line for guiding fuel between the fuel reservoir and the aircraft engine.

8. The aircraft according to claim 7, wherein the aircraft engine is a turbine.

9. The aircraft according to claim 6, wherein the fluid transmitting equipment is a hydraulic pump, the fluid receiving equipment is a hydraulic motor, and the conduit is a hydraulic line for guiding a hydraulic fluid between the hydraulic pump and the hydraulic motor.

10. The aircraft according to claim 9, wherein the hydraulic motor is a hydraulic actuator.

11. A method for manufacturing a tube comprising the steps:
providing a melt of an austenitic stainless steel comprising, in weight %,
C≤0.080,
8.00≤Mn≤10.00,
Si≤1.00,
P≤0.030,
S≤0.030,
19.00≤Cr≤21.50,
5.50≤Ni≤7.50,
0.15≤N≤0.40,
Mo≤0.75,
Cu≤0.75,
balance Fe and normally occurring impurities;
extruding a billet from the melt;
hot forming of the billet into a tubular hollow;
cooling the hollow; and
cold forming the hollow into the tube.

12. The method according to claim 11, wherein the hollow is cold formed by cold pilger milling, and wherein the tube after cold pilger milling is cold drawn.

13. The method according to claim 11, wherein the tube after cold forming is treated by ring autofrettage or ball autofrettage.

14. The method according to claim 13, wherein the tube after cold pilger milling is annealed at a temperature in a range from 400° C. to 460° C., and wherein during annealing the tube is kept in a controlled atmosphere.

15. A use of a tube according to claim 1 for guiding a fluid in an aircraft.

16. The method according to claim 12, wherein the tube after cold forming is treated by ring autofrettage or ball autofrettage.

17. The method according to claim 16, wherein the tube after cold pilger milling is annealed at a temperature in a range from 400° C. to 460° C., and wherein during annealing the tube is kept in a controlled atmosphere.

18. The method according to claim 11, wherein the tube after cold pilger milling is annealed at a temperature in a range from 400° C. to 460° C., and wherein during annealing the tube is kept in a controlled atmosphere.

19. The method according to claim 12, wherein the tube after cold pilger milling is annealed at a temperature in a range from 400° C. to 460° C., and wherein during annealing the tube is kept in a controlled atmosphere.

20. The aircraft according to claim 7, wherein the fluid transmitting equipment is a hydraulic pump, the fluid receiving equipment is a hydraulic motor, and the conduit is a hydraulic line for guiding a hydraulic fluid between the hydraulic pump and the hydraulic motor.
